(19) United States
(12) Patent Application Publication
(10) Pub. No.: US 2011/0027528 A1
(43) Pub. Date: Feb. 3, 2011

(54) GAS DIFFUSER MEMBRANE WITH COATED SUBSTRATE AND METHOD FOR MANUFACTURING THE SAME

(76) Inventors: Charles E. THARP, Columbia, MO (US); Warrick S. Wadman, Columbia, MO (US); David A. Capron, Columbia, MO (US); Glen K. Wylie, Columbia, MO (US)

Correspondence Address: HUSCH BLACKWELL LLP, 4801 Main Street, Suite 1000, KANSAS CITY, MO, 64112, US

(21) Appl. No.: 12/905,895

(22) Filed: Oct. 15, 2010

Related U.S. Application Data
(63) Continuation-in-part of application No. 11/428,431, filed on Jul. 3, 2006, now Pat. No. 7,815,974.

(51) Int. Cl. B32B 3/10; B29C 71/00; B05D 3/12; B05D 3/06; B29C 47/00; B05D 3/10

(52) U.S. Cl. 428/137; 264/129; 427/256; 427/534

(57) ABSTRACT

A flexible diffuser membrane for diffusing gas into a liquid includes a substrate covered wholly or partially by a thin coating. The substrate is formed by a mold or extruder and is of an elevated temperature upon exiting the mold or extruder. The coating may be applied directly to a selected surface of the substrate just after it exits the mold or extruder and while the substrate is at an elevated temperature and before it may become contaminated by foreign materials. The membrane's manufacturing process may be a substantially continuous process wherein the substrate is continuously formed by an extruder and the coating is applied to the substrate in a continuous manner as the substrate exits the extruder.

### CROSS-REFERENCE TO RELATED APPLICATIONS

This Application is a Continuation-in-Part Application of and claims priority to U.S. application Ser. No. 11/428,431 filed Jul. 3, 2006 to Charles E. Tharp entitled “Gas Diffuser Membrane With Coated Substrate,” currently pending, the entire disclosure of which is hereby incorporated by reference to the extent permitted by law.

### FIELD OF THE INVENTION

This invention relates generally to the field of gas diffusion and more particularly to a gas diffuser membrane including a substrate having a coating applied directly thereon and a method for manufacturing the same.

### BACKGROUND OF THE INVENTION

Flexible membrane diffusers have been used in the diffusion of gases into liquids, one example being the aeration of wastewater. The flexible membranes have been used with tubular and disc type diffusers. Exemplary of a tubular membrane diffuser is U.S. Pat. No. 4,960,546 to Tharp.

Flexible membrane diffusers are conventionally constructed of rubber or a similar material which is punctured to provide a large number of perforations. When gas is applied to the diffuser, the gas pressure expands the membrane away from the diffuser body and causes the perforations to open so that the gas discharges through them in the form of fine bubbles, which transfer gas efficiently to the liquid. When the gas pressure is relieved, the membrane collapses on the diffuser body to close the perforations and prevent the liquid from entering the diffuser.

Although flexible membrane diffusers are advantageous in many respects and have achieved widespread acceptance in a variety of gas diffusion applications, they are not wholly free of problems. Rubber or synthetic rubber is typically used to construct the membrane. In a wastewater treatment application and in other applications, materials in the liquid can become deposited on and build up on the membrane to clog or partially clog the perforations and thus reduce the efficiency of the diffuser. For example, fats, grease and other substances which are commonly found in wastewater can adhere to the membrane. Calcium and calcium compounds such as calcium carbonate and calcium sulfate as well as other substances are especially problematic when they precipitate and build up on the diffuser membrane. Biological growth can also build up and compromise the diffuser efficiency. Diffuser membranes can also be chemically degraded by solvents and various other types of chemicals that may be present in the liquid. This chemical degradation combined with the repeated expansion and contraction of the membrane can weaken the membrane and cause premature structural failure.

One solution to these problems has been to apply a coating to the membrane in order to provide the membrane with a relatively slick surface that resists biological growth and other materials from being deposited thereon. However, the application of the coating is itself not without problems. It is often difficult to establish high bond strengths between the membrane's substrate layer and coating layer, in part, because of the non-adhesive qualities of the coating layer. Various methods have been proposed to address this problem.

One approach is to use an adhesive, bonding or primer layer between the substrate and the coating. By way of example, U.S. Pat. No. 6,759,129 to Fukushi discloses the application of a “bonding” layer between the substrate and coating and U.S. Pat. No. 7,674,514 to Frankel et al. and U.S. Patent Publication No. 2007/0001323 to Kang disclose the application of a “primer” layer between the substrate and coating. Not only does this approach add additional steps, complications and materials in the manufacturing process, but it also results in an increase of the overall product cost.

Another approach is to apply a cured film with an uncured bonding agent to an uncured substrate foil led of polytetrafluoroethylene (PTFE). However, a PTFE substrate is typically more rigid than an elastomeric substrate which creates the undesirable affect of a higher pressure loss across the membrane and greater permanent set which could lead to lower oxygen transfer efficiencies.

Yet another approach is to apply an uncured film to a pre-cured substrate and curing them together in a mold. By way of example, U.S. Pat. No. 7,396,499 to Frankel et al. discloses placing an uncured thin fluoroelastomer film to a pre-cured substrate layer and curing in a high temperature mold. This approach is also disadvantageous in a number of respects. First, because both the substrate and film are in an uncured state, it is not possible to optimize both the curing of the substrate and the bonding of the film to the substrate. The time and temperature requirements for curing differ from those necessary to achieve optimal bonding between the two materials, so either the curing or the bonding must necessarily be compromised. The result is a product that has either an inadequately cured substrate or an inadequate bond between the layers. Second, this approach adds additional steps and complications in the manufacturing process and also results in an increase of the overall product cost. Third, there is no opportunity to clean the substrate because the curing process is interrupted and is only partially completed at the time the film is applied. If contaminants are present, they cannot be removed by solvents or other cleaning processes and can interfere with the bonding to the point of destroying any ability to properly bond the materials together. Fourth, the disclosed fluoroelastomer layer must be applied as a film, thus making it impossible to apply the coating layer in other manners or methods which may be preferable in some cases. For similar reasons, the ability to vary the coating thickness is limited. Finally, this may only be used to produce diffuser membranes that are molded and cannot readily be used to produce diffuser membranes that are extruded.

### SUMMARY OF THE INVENTION

The present invention is directed to an improved flexible diffuser membrane and to an improved method of constructing a flexible membrane which takes advantage of the benefits of a flexible material as a substrate while providing a coating which acts to resist chemical attack and material buildup on the membrane.

In accordance with a preferred embodiment of the invention, a flexible diffuser membrane applicable to a diffuser body for diffusing gas into a liquid is uniquely constructed to take full advantage of the desirable qualities of both conventional membrane materials and coating materials, using a novel process to construct the membrane. The substrate is formed by a mold or extruder and, due to the heat used in the forming process, is of an elevated temperature upon exiting the mold or extruder. In one embodiment, a coating is applied to a selected surface of the substrate while the substrate is at the elevated temperature. Because the substrate is at an elevated temperature, the substrate's microscopic pores may be in an expanded state. Additionally, to the extent the substrate material includes a curing agent, the heat may draw at least a portion of the curing agent away from the selected surface thereby further facilitating the formation of a high strength bond between the substrate and the coating. Under this method, the coating may be applied to the substrate directly after it exits the mold or extruder and before the substrate is handled or has a chance to become contaminated. The coating may be applied to the selected surface without any primer layer therebetween. The membrane's manufacturing process may be a continuous process wherein the substrate is continuously formed by an extruder and the coating is applied to the substrate in a continuous manner as the substrate exits the extruder.

The present invention is also directed to an embodiment for constructing a flexible diffuser membrane wherein the coating is not immediately applied to the substrate upon the substrate's formation but rather is applied at a later point in time. This embodiment includes a cleaning process by which contaminants and foreign materials may be removed from the surface of the substrate on which the coating is to be applied. The cleaning process may be done with a solution or treatment designed to remove bonding inhibiting materials from the selected surface. The treatment may include one or more of a cool gas or liquid treatment, a Corona (i.e., air plasma) treatment, a plasma treatment, a solvent treatment, other suitable treatments or combinations thereof. The treatment may be in one or more of a liquid state, a gaseous state, a solid state, a supercritical fluid state, a plasma state or any combinations thereof.

The result is a flexible membrane that takes advantage of the structural integrity and flexibility of the substrate while having a coating that resists adhesion of foreign materials, biological buildup and chemical degradation. At the same time, the membrane may be formed of only two layers (i.e., a coating layer applied directly to a substrate layer) and may not employ any primer therebetween. The process for constructing the membrane is simple, efficient, and cost effective.

### BRIEF DESCRIPTION OF THE SEVERAL VIEWS OF THE DRAWINGS

In the accompanying drawings:

FIG. 1 is a fragmentary perspective view of a portion of an aeration system for aerating wastewater that is equipped with a tubular diffuser having a flexible membrane constructed according to one embodiment of the present invention;

FIG. 2 is a fragmentary enlarged view of one of the perforations identified in FIG. 1 by detail 2;

FIG. 3 is a sectional view of the membrane on an enlarged scale taken generally along line 3-3 of FIG. 1 in the direction of the arrows, with the coating thicknesses exaggerated for purposes of illustration constructed according to one embodiment of the present invention; and

FIG. 4 is an enlarged fragmentary sectional view of a membrane that may be used with a disc type diffuser, with the coating thickness exaggerated for purposes of illustration constructed according to one embodiment of the present invention.

### DETAILED DESCRIPTION OF THE INVENTION

The present invention is directed to a flexible diffuser membrane and to a process of constructing the membrane. Membranes of this type are used in various applications in which gases of various types are diffused into liquids of various types. One example is a wastewater treatment system in which flexible membrane diffusers are commonly used to diffuse air into the wastewater for aeration and mixing purposes. Flexible membrane diffusers are used in this type of application both on tubular diffusers and disc diffusers.

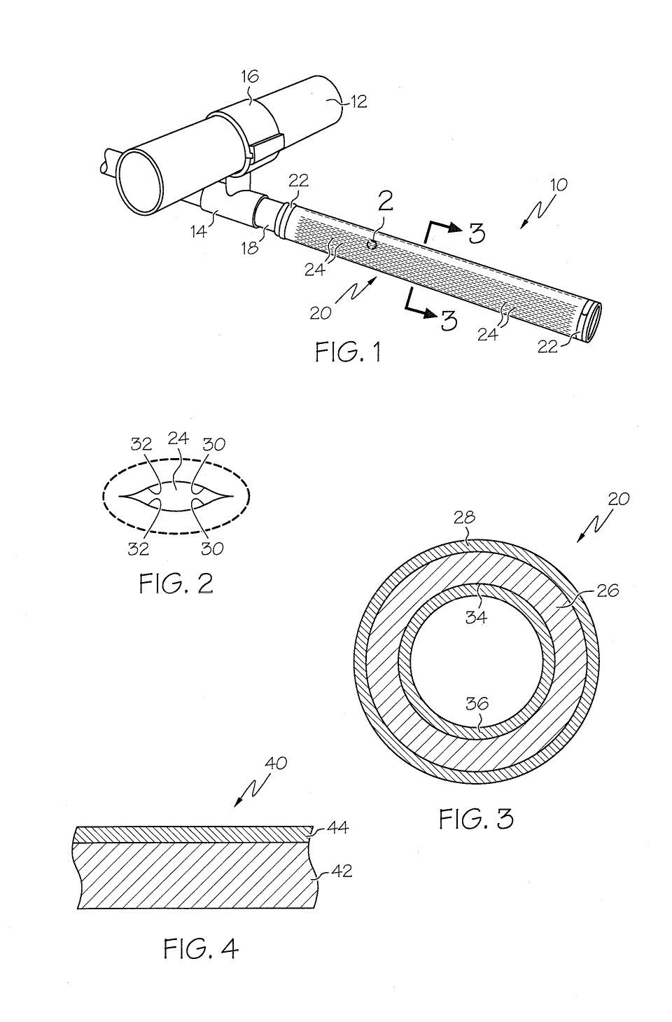

While FIG. 1 depicts a tubular membrane diffuser generally identified by numeral 10, it is to be understood that the invention is equally applicable to membranes for disc diffusers and other types of diffusers that are used both in water and wastewater treatment as well as in the diffusion of various types of gases into other liquids.

The diffuser 10 is used in aeration system which includes a variety of air lateral pipes such as the pipe 12 which may be floating on the surface of the liquid or submerged. Air or another gas is supplied to the pipe 12 and is discharged into a tee-fitting 14 connected with a saddle structure 16 used to mount the diffuser assembly on the pipe 12. FIG. 1 depicts tubular diffusers extending from each of the side outlets of the tee-fitting 14 (one shown only fragmentarily), although other arrangements are possible. Diffuser systems and structures different from what is shown in FIG. 1, including those described and shown in U.S. Provisional Patent Application Nos. 61/381,900 and 61/382,745, are within the scope of the invention.

As shown in FIG. 1, the diffuser 10 includes a hollow rigid diffuser body 18 which is connected with an outlet of the tee-fitting 14 and extends generally horizontally. The diffuser body 18 is provided with one or more openings (not shown) which discharge the gas within a flexible membrane 20 secured to the diffuser body 18 by band clamps 22 or other suitable fasteners. The membrane 20 is provided with a plurality of small perforations 24 which may take the form of slits arranged in any desired pattern.

When air is applied to the diffuser body 18 from the lateral pipe 12, the gas pressure causes the membrane 20 to expand from the diffuser body 18, thus opening the perforations 24 and discharging the gas through the perforations into the liquid in the form of fine bubbles which are beneficial in that they efficiently transfer the gas to the liquid. When the gas pressure is relieved, the flexible membrane 20 collapses back onto the diffuser body 18 and thus closes the perforations 24 so that the liquid is unable to leak into the diffuser.

The present invention is directed specifically to the construction of the membrane 20 and 40. As best shown in FIGS. 3 and 4, the method described herein may be used in constructing membranes 20 having a tubular shape and membranes 40 that may be of a disc shape. The substrate 26 or 42 may be constructed of any suitable material that exhibits the necessary structural properties and flexibility. Examples of materials that are suitable for the substrate 26 or 42 include natural rubber, ethylene propylene diene monomer (EPDM), polyurethane, nitrile rubber, butyl rubber, silicone rubber, natural rubber, other suitable polymers and flexible materials having the necessary qualities, and combinations thereof. The substrate 26 or 42 may be formed through either a molding process or an extrusion process. For example, the substrates 26 of tube type membranes 20 are typically formed in an extrusion process, whereas the substrates 42 of disc type membranes 40 are typically formed in a molding process. The substrate 26 or 42 may optionally be impregnated or otherwise treated with a biocide agent in order to protect the edges 30 of perforations 24 formed therein from the buildup of biological growth and other deposited materials.

The substrate 26 or 42 is provided with a coating 28 or 44 which may cover the entire outside or top surface of the substrate 26 or 42 or any selected part of the substrate, depending upon the application in which the diffuser is to be used. As depicted in FIG. 3, a tube type membrane 20 may optionally be provided with both a coating 28 on its outer surface and a coating 36 on its inner surface 34. The coating 28, 36 or 44 may be of a single layer comprising one or more of the following materials: urethane, polyurethane, silicone, a fluoropolymer, polytetrafluoroethylene (PTFE), acrylic, any other suitable coating materials, or combinations thereof. Other suitable coating materials include materials that can be adequately bonded to the substrate 26 or 42 and have the ability to resist solvents and other chemicals and to resist adhesion of fat, grease, biological growth and other contaminants in the liquid that can damage conventional elastomers and other membrane materials. The coating 28, 36 or 44 also creates a barrier from materials exiting the substrate 26, 42 and/or entering the substrate 26, 42. The coating 28, 36 or 44 may be mixed with a catalyst that may be of any suitable type selected to effect a strong bond with the substrate 26 or 42.

To the extent that the coating 28, 36 or 44 includes more than one material, the coating 28, 36 or 44 may be of a generally homogeneous matrix having a generally uniform consistency throughout its thickness and does not have any pronounced multiple layering effects. As illustrated in FIGS. 3 and 4, the coating 28, 36 or 44 is applied directly to the substrate 26 or 42 and does not include any bonding or primer layer therebetween. The surface coating 28, 36 or 44 is of nominal thickness relative to the substrate layer 26 or 42 and protects the substrate layer 26 or 42 from substances such as biofilm, biological growth, calcium and calcium compounds, gypsum, fats, oils, greases and solvents.

The membrane 20 or 40 is constructed by first manufacturing the substrate 26 or 42. Again, the substrate 26 of a tube type membrane 20, like that show in FIG. 4, is typically formed in an extrusion process, whereas the substrate 42 of a disc type membrane, like that show in FIG. 4, is typically formed in a molding process. Upon exiting the extruder or mold in which it is formed, the substrate 26 or 42 is typically of an elevated temperature as compared to its ambient surroundings. Upon exiting an extruder, the substrate 26 or 42 can be in a range from about 100° F. to 300° F., and in one embodiment is in a range from about 150° F. to 210° F. Upon exiting a mold, the substrate 26 or 42 can be in a range from about 275° F. to 425° F., and in one embodiment is in a range from about 320° F. to 370° F.

In one embodiment of the method, the coating 28, 36 or 44 is applied to the heated substrate 26 or 42 directly after the substrate 26 or 42 exits the extruder or the mold in which it was formed. The coating 28, 36 or 44 may be applied to the substrate 26 or 42 in the same location or a location adjacent to the mold or extruder. In order to avoid contamination, the substrate 26 or 42 is preferably not handled or transported to a different location within the manufacturing facility prior to the coating 28, 36 or 44 being applied. The coating 28, 36 or 44 may be applied within the first 30 seconds of the substrate 26 or 42 exiting the extruder or the mold, or alternatively within the first 10 seconds of the substrate 26 or 42 exiting the extruder or the mold. In one embodiment, the coating 28, 36 or 44 may be applied within the first few seconds of the substrate 26 or 42 exiting the extruder or the mold. Even though the substrate 26 or 42 may be at an elevated temperature, it can utilize a curing procedure that will rapidly and completely cure the substrate. Optionally, additional heat may be added to the substrate 26 or 42 after it exits the extruder or the mold but before the coating 28, 36 or 44 is applied. In such a case, heat may be added through the use of a microwave device or heating oven, which may elevate the temperature of the substrate 26 or 42 to a range from about 250° F. to 500° F., and in one embodiment to a range from about 300° F. to 450° F.

The heat from the substrate 26 or 42, as well as the fact that the coating 28, 36 or 44 is applied directly after the substrate 26 or 42 exits the extruder or mold, is beneficial in establishing high bond strengths between the substrate 26 or 42 and coating 28, 36 or 44. The heat contained within the substrate 26 or 42 expands the material's surface openings or pores and acts as a catalyst for bonding the coating 28, 36 or 44 to the surface of the substrate material. Additionally, many materials from which the substrate 26 or 42 may be constructed from, including compounds such as rubber or EPDM, have curing compounds or agents within their mixture. The application of the coating 28, 36 or 44 while the substrate 26 or 42 is still hot takes advantage of a known characteristic that the curing agents and other chemicals remain trapped inside the substrate material and are not concentrated at the surface of the substrate 26 or 42. For example, when substrates 26 or 42 formed from EPDM are allowed to cool, the curing agents have a tendency become concentrated on the outer surface of the substrate 26 or 42 thereby causing an impediment and barrier to the proper bonding of the single layer coating 28, 36 or 44. In this method, the coating 28, 36 or 44 may be applied to the substrate 26 or 42 before some or all of the curing agents have migrated to the substrate's surface. Additionally, the heat contained in the substrate material accelerates the curing time of the coating 28, 36 or 44 and minimizes the energy cost in the production process.

In order to form the strongest possible bond between the substrate 26 or 42 and the coating 28, 36 or 44, it is extremely important that a proper substrate surface be available on which the coating 28, 36 or 44 is to be applied. Applying the coating 28, 36 or 44 to the substrate 26 or 42 directly after the substrate 26 or 42 exits the extruder or mold in which it is formed avoids any contamination and general mechanical abrasion and abuse that may occur to the substrate surface during transport, storage and handling. Applying the coating 28, 36 or 44 to the substrate 26 or 42 directly at the substrate's point of manufacture eliminates fingerprints, oils, greases, dust, dirt, foreign materials and other contaminants that may interfere with the bonding of the coating 28, 36 or 44 to the substrate surface. Unlike some prior art, once the coating 28, 36 or 44 is applied to the substrate 26 or 42, the combine product need not be placed in or onto any type of mold to facilitate the completion of the curing process.

The coating 28, 36 or 44 may be applied to the substrate 26 or 42 by manners such as spraying, brushing, rolling, dipping, electrostatic application, other suitable application techniques which may be preferable in some cases, or combinations thereof. The method of applying the coating 28, 36 or 44 may be a substantially continuous process. For example, in the case of an extruded substrate 26, the substrate 26 may be flowing continuously from the extruder and may be sprayed with the coating 28 a short distance after its exit point from the extruder. It should be understood, however, that it is within the scope of the present invention to have the substrate 26 or 42 undergo a cleaning process or application subsequent to exiting the extruder or mold in which it is formed but prior to the application of the coating 28, 36 or 44. This cleaning process may also be a continuous process and may take place directly after the substrate 26 or 42 exits the extruder or mold in which it is formed or after it exits a heating device, such as a microwave device or heating oven, in which heat is added to the substrate 26 or 42. The cleaning process may occur directly adjacent to and in the same line as the extruder, mold and/or heating device.

In cases where PTFE is included in the coating 28, 36 or 44, it may be included in concentrations above about 5%. or more, for particularly harsh or heavy duty applications. One embodiment of the method, wherein the coating 28, 36 or 44 is sprayed onto the substrate 26 or 42 directly after the substrate 26 or 42 exits the extruder or mold, with or without cleaning, makes it possible to effectively spray coat a substrate 26 or 42 with a coating 28, 36 or 44 containing a relatively high concentration of PTFE (e.g., 5% or more) without the use of an intermediate primer of bonding layer. Absent the heat and surface condition contained in the substrate 26 or 42, bonding issues may arise between the substrate 26 or 42 and coating 28, 36 or 44.

After the coating 28, 36 or 44 has been applied to the desired thickness, the substrate 26 or 42 and coating 28, 36 or 44 may optionally be heated to an elevated temperature selected to achieve sintering or bonding of the coating to the substrate creating maximum cross-linking, chemical bonding, molecular bonding and adhesive bonding of the coating 28, 36 or 44 to the substrate 26 or 42. However, as set forth above, the substrate 26 or 42 is of an elevated temperature, having just exited the extruder or mold, with or without surface cleaning, when the coating 28, 36 or 44 is applied and, therefore, such additional heat in some embodiments may not be necessary or preferred. If additional, supplemental heat is applied, the amount of heat applied to the combined substrate 26 or 42 and coating 28, 36 or 44 may be of a reduced amount due to the fact that the substrate 26 or 42 is already of an elevated temperature. Depending upon the materials, the temperature to which the combined substrate 26 or 42 and coating 28, 36 or 44 is heated to obtain maximum bonding may be in the range of about 350° F. to about 800° F. In one embodiment, the combined substrate 26 or 42 and coating 28, 36 or 44 are heated together to a temperature between approximately 600° F. and 700 F. The sintering or cross-linking and chemical, molecular or bonding effected by heating to these temperature ranges, together with the presence of the catalyst, creates a bond between the coating 28, 36 or 44 and substrate 26 or 42 which is able to withstand the forces applied to the membrane 20 or 40 in normal service.

Turning attention now to another embodiment of the present invention. Under this embodiment, the coating 28, 36 or 44 is not applied to the substrate 26 or 42 right after it exits the extruder or mold in which it is formed. Rather, the coating 28, 36 or 44 is applied at some later point in time. Therefore, in this embodiment, the substrate 26 or 42 is exposed to a cleaning process prior to the application of the coating 28, 36 or 44 in order to remove any contaminants (e.g., fingerprints, oils, greases, dust, dirt, foreign materials, etc.) that may interfere with the strength of the bonding of the coating 28, 36 or 44 to the substrate 26 or 42. After the substrate 26 or 42 has been adequately cleaned, the coating 28, 36 or 44 is applied.

The surface cleaning process may include one of a variety of treatments, including surface blasting with a gas treatment, a Corona (i.e., air plasma) treatment, a plasma treatment, a solvent treatment, other suitable treatments or any combination thereof. The treatment applied to the substrate surface in any of these processes may be in one or more of various states, including liquid, gaseous, solid, supercritical fluid, plasma or any combinations thereof. These processes may be designed to remove bonding inhibiting materials out of the substrate 26 or 42, thus leaving the substrate 26 or 42 with a surface having little or no inhibiting materials on it. These treatment processes are designed to prepare a clean substrate surface, and in some cases prepare a substrate surface texture, for allowing enhanced adhesion of the coating 28, 36 or 44 to the substrate 26 or 42 without the use of an intermediate primer or bonding layer. Typically, the surface cleaning process does not leave a residue behind on the substrate surface and does not act as a primer between the substrate 26 or 42 layer and the coating 28, 36 or 44 layer. After the substrate surface has undergone the cleaning process, the coating 28, 36 or 44 may be applied to the substrate 26 or 42.

As set forth above with the other various embodiments, after the coating 28, 36 or 44 has been applied to the desired thickness, the substrate 26 or 42 and coating 28, 36 or 44 may be together heated to an elevated temperature to affect the strongest possible bond between the coating 28, 36 or 44 and substrate 26 or 42 so that the coating 28, 36 or 44 is not susceptible to peeling off of or separation from the substrate 26 or 42 in service.

After the coating 28, 36 or 44 has been applied to the substrate 26 or 42 in any of the methods described above, the perforations 24 are formed through the coating and substrate by conventional techniques. As best shown in FIG. 2, each of the perforations 24 presents edges 30 which are devoid of the coating 28. This is a desirable effect because it maintains the perforation edges 30 as the hydrophilic material of the substrate 26 or 42. As a result of this hydrophilic quality of the edges 30, the bubbles that are released from the membrane 20 or 40 into the liquid are extremely fine bubbles which are efficient in transferring gas to the liquid and thus enhance the overall efficiency of the gas diffusion process. In some embodiments, this is not required or preferred however.

If desired, the body of the substrate 26 or 42 may be treated with a suitable biocide agent as disclosed in U.S. Pat. No. 6,543,753 to Tharp, and when the coating is perforated, this biocide agent will be exposed to the liquid being treated and prevent or resist the build up of biological growth on the edges 30. Avoiding biological growth is of significant importance and is therefore preferred in that it maintains the perforations 24 in an unclogged state and is particularly preferred if the diffuser is used in a severe biological environment. Any suitable biocidal agent may be used, including biocides disclosed in U.S. Pat. No. 6,543,753 to Tharp.

The coatings 28, 36 or 44 prevent contaminants in the liquid or waste being aerated from becoming deposited on and accumulating on the membrane 20 or 40, as the coating 28, 36 or 44 presents a smooth, slick and/or nonstick surface that resists adhesion of the foreign materials. The coatings 28, 36 or 44 are also beneficial in that they resist the growth of biological materials that could otherwise build up on the substrate 26 or 42. The coatings 28, 36 or 44 are also resistant to chemicals and other solvents that can chemically attack and degrade or destroy the substrate 26 or 42.

Accordingly, the membrane 20 or 40 of the present invention takes advantage of the beneficial attributes of the substrate 26 or 42 (physical and structural properties and flexibility) along with the protective qualities provided by the coating 28, 36 or 44. At the same time, the efficiency of the membrane 20 or 40 is enhanced by maintaining the perforations 24 unclogged and having the body of the diffuser or the substrate treated with the biocide agent 32 which then presents biocide treated edges of the opening 30 to the wastewater and avoids any biological build up in the perforations 24 which could inhibit their ability to discharge the gas.

The process by which the membrane 20 or 40 is constructed is advantageous in that it is simple and inexpensive. By completely constructing the substrate 26 or 42 before the coating 28, 36 or 44 is applied, the substrate 26 or 42 can be constructed to provide the optimal physical qualities. The heat added to the substrate 26 or 42 during the extrusion or molding process may be taken advantage of during the cleaning and/or application of the coating 28, 36 or 44 thereby reducing the heat and energy requirements necessary for producing the finished product.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A process for constructing a flexible diffuser membrane applicable to a diffuser body for diffusing gas into a liquid, said process comprising the steps of:
providing a substrate constructed of a flexible material, said substrate having an elevated temperature upon exiting a mold or extruder; and
applying a coating on a selected surface of said substrate after the substrate has exited the mold or extruder and while said substrate is at said elevated temperature.

2. A process as set forth in claim 1, wherein said coating is applied to said substrate directly after said substrate exits said mold or extruder.

3. A process as set forth in claim 1, wherein said coating is applied to said substrate at a location directly adjacent to the mold or extruder in which the substrate was formed.

4. A process as set forth in claim 1, wherein said substrate is not handled prior to the coating being applied thereon.

5. A process as set forth in claim 1, wherein said coating is applied directly to said selected surface without any primer layer therebetween.

6. A process as set forth in claim 1, wherein said elevated temperature is between about 150° F. and 370° F.

7. A process as set forth in claim 1, wherein said substrate is fully cured prior to the application of said coating.

8. A process as set forth in claim 1, wherein said coating is comprised of at least about 5% polytetrafluoroethylene (PTFE).

9. A process as set forth in claim 1, wherein said substrate includes microscopic pores, said microscopic pores being in an expanded state when said substrate is at said elevated temperature thereby facilitating the formation of a bond between said substrate and coating.

10. A process as set forth in claim 1, wherein said substrate includes a curing agent and wherein heat within said substrate draws at least a portion of the curing agent away from said selected surface thereby facilitating the formation of a bond between said substrate and coating.

11. A process as set forth in claim 1, wherein said substrate is generally continuously formed by an extruder and said coating is applied to said substrate in a generally continuous manner as said substrate exits said extruder.

12. A process as set forth in claim 1, wherein said coating is applied to said substrate within 10 seconds of the substrate exiting the mold or extruder in which the substrate was formed.

13. The product as produced by the process of claim 1.

14. A process for constructing a flexible diffuser membrane applicable to a diffuser body for diffusing gas into a liquid, said process comprising the steps of:
providing a substrate constructed of a flexible material;
cleaning a selected surface of said substrate with treatment for removing contaminants and foreign materials therefrom; and
applying a coating on said selected surface of said substrate.

15. A process as set forth in claim 14, wherein said treatment is designed to remove bonding inhibitors from said selected surface.

16. A process as set forth in claim 14, wherein said treatment includes at least one of a gas treatment, a liquid treatment, a Corona treatment, a plasma treatment, a solvent treatment, other suitable treatments now known or hereafter developed or any combination thereof.

17. A process as set forth in claim 14, wherein said treatment is in one or more of a liquid state, a gaseous state, a solid state, a supercritical fluid state, a plasma state or any combinations thereof.

18. A process as set forth in claim 14, wherein said steps of cleaning said selected surface and applying said coating thereon occur directly after said substrate exits said mold or extruder.

19. A process as set forth in claim 14, wherein said steps of cleaning said selected surface and applying said coating thereon occur offline and away from the location where said substrate is formed.

20. The product as produced by the process of claim 14.

21. A flexible diffuser membrane applicable to a diffuser body for diffusing gas into a liquid, said membrane comprising:
a substrate constructed of a flexible material and formed in a mold or extruder; and
a coating that is applied directly to a selected surface of said substrate generally immediately after said substrate has exited the mold or extruder and said substrate is at an elevated temperature.
